(19) United States
(12) Patent Application Publication
(10) Pub. No.: US 2014/0006294 A1
(43) Pub. Date: Jan. 2, 2014

(54) Technology Trend Analysis Report Generating System and Recording Medium

(71) Applicant: Korea Atomic Energy Research Institute, Daejeon (KR)

(72) Inventors: Jae-Bok Yoo, Daejeon (KR); Jae-Ho Kim, Daejeon (KR)

(21) Appl. No.: 13/928,723

(22) Filed: Jun. 27, 2013

(30) Foreign Application Priority Data
Jun. 28, 2012 (KR) 10-2012-0069740

(51) Int. Cl. G06Q 50/18; G06Q 10/06

(52) U.S. Cl. CPC G06Q 50/184; G06Q 10/06
USPC 705/310

(57) ABSTRACT

The following disclosure relates to a technology trend analysis report generating system and a recording medium, and more particularly, to a technology trend analysis report generating system analyzing a trend of a patent technology selected as an analysis object and providing a report for each analysis unit to automatically generate an integrated report including various analysis contents in response to a user request and a recording medium.

### CROSS-REFERENCE TO RELATED APPLICATIONS

This application claims priority under 35 U.S.C. §119 to Korean Patent Application No. 10-2012-0069740, filed on Jun. 28, 2012 in the Korean Intellectual Property Office, the disclosure of which is incorporated herein by reference in its entirety.

### TECHNICAL FIELD

The following disclosure relates to a technology trend analysis report generating system and a recording medium, and more particularly, to a technology trend analysis report generating system analyzing a trend of a patent technology selected as an analysis object and providing a report for each analysis unit to automatically generate an integrated report including various analysis contents in response to a user request and a recording medium.

### BACKGROUND

Today, in case of National R&D Program, Korea Law regulates that a domestic and foreign patent needs to be searched in a planning stage. Further, in order for each organization, such as businesses, universities, and research organizations, to actually utilize patent trend analysis for each technology field, overlap research prevention, research project planning/selection/evaluation, vacant/niche technology derivation, project program writing, research and development strategy, and the like, a patent map has been largely emphasized.

However, a patent trend analysis report written once is generally used only once and high-quality processed patent data used at the time of writing the patent trend analysis report have been discarded without being managed well or reused.

Therefore, even though a nation or each organization performed a patent map for each technology field according to the purpose from the past, the patent map report needs to be written through outsourcing or a use of an expert when intending to perform a new R&D program for the corresponding technology field.

At national or organization level, the situations above repeatedly incur a waste of unnecessary manpower and budget, and therefore, a method for solving this problem needs to be found.

### RELATED ART DOCUMENT

### Patent Document

Korean Patent Laid-Open Publication No. 10-2010-0029903 (Laid-Open Publication Date: Mar. 18, 2010)
Korean Patent Laid-Open Publication No. 10-2006-0122756 (Laid-Open Publication Date: Nov. 30, 2006)
US Patent Laid-Open Publication No. 20040083422 (Laid-Open Publication Date: Apr. 29, 2004)

### SUMMARY

An exemplary embodiment of the present invention is directed to providing a technology trend analysis report generating system capable of allowing general researchers to easily and rapidly write a patent trend analysis report by reusing high-quality processed patent data already used at the time of writing the patent trend analysis report and a recording medium.

In one general aspect, there is provided a technology trend analysis report generating system, including: a registration data storage unit that stores a plurality of pre-registered technology data for a technology trend analysis report; an analysis object selection module that selects at least one technology data to be used as an analysis object in response to a user request from the registration data storage unit; a report generating module for each analysis unit that analyzes at least one technology data selected by the analysis object selection module depending on a preset analysis reference and generates at least one report for each analysis unit including results analyzed depending on the analysis reference and a preset example sentence for description; and an integrated report generating module that combines at least one report for each analysis unit generated from the report generating module for each analysis unit depending on a preset technology trend analysis report format to generate a technology trend analysis report.

In another general aspect, there is provided a computer-readable recording medium recorded with a program executing a method for generating a technology trend analysis report, the method for generating a technology analysis report including: selecting at least one technology data to be used as an analysis object in response to a user request among a plurality of pre-registered technology data for a technology trend analysis report; analyzing the at least selected technology data depending on a preset analysis reference and generating at least one report for each analysis unit including results analyzed depending on the analysis reference and a preset example sentence for description; and combining the at least one generated report for each analysis unit depending on the preset technology trend analysis report format to generate a technology trend analysis report.

### BRIEF DESCRIPTION OF THE DRAWINGS

FIG. 1 is a diagram illustrating a system configuration diagram illustrating a configuration of a technology trend analysis report generating system according to an exemplary embodiment of the present invention.

FIG. 2 is a diagram illustrating a first exemplary embodiment related to an analysis object search of the present invention.

FIG. 3 is a diagram illustrating a second exemplary embodiment related to an analysis object search of the present invention.

FIG. 4 is a diagram illustrating a third exemplary embodiment related to an analysis object search of the present invention.

FIG. 5 is a diagram illustrating an exemplary embodiment related to analysis object editing of the present invention.

FIG. 6 is a diagram illustrating a first exemplary embodiment related to a report generation for each analysis unit of the present invention.

FIG. 7 is a diagram illustrating a second exemplary embodiment related to a report generation for each analysis unit of the present invention.

FIG. 8 is a diagram illustrating a third exemplary embodiment related to a report generation for each analysis unit of the present invention.

FIG. 9 is a diagram illustrating a fourth exemplary embodiment related to a report generation for each analysis unit of the present invention.

FIG. 10 is a diagram illustrating an exemplary embodiment related to a technology trend analysis report generation of the present invention.

FIG. 11 is a diagram illustrating an exemplary embodiment related to a technology trend analysis report management of the present invention.

### DETAILED DESCRIPTION OF EMBODIMENTS

Embodiments of the present invention will now be described in detail with reference to the accompanying drawings. It is to be noted that like components are denoted by like reference numerals anywhere in the drawings, if possible. Further, a detailed description of a known and data function and a configuration that may unnecessarily obscure a subject of the present invention will be omitted.

Hereinafter, a technology trend analysis report generating system according to an exemplary embodiment of the present invention may generate a patent trend analysis report based on patent data as a representative exemplary embodiment of a technology trend analysis report.

Further, the technology trend analysis report generating system according to the exemplary embodiment of the present invention may also generate a technology trend analysis report based on paper data. This may vary depending on whether technology data prefetched as an analysis object to the technology trend analysis generating system according to the exemplary embodiment of the present invention correspond to any technology information.

Herein, the exemplary embodiment of the present invention describes that the technology trend analysis report generating system generates the patent trend analysis report based on the case in which the patent data are prefetched, but is not restrictively used only for the patent trend analysis.

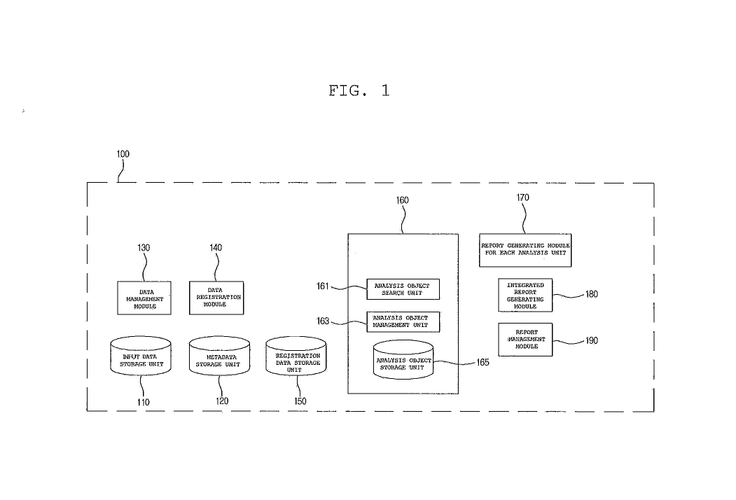

FIG. 1 is a diagram illustrating a system configuration diagram illustrating a configuration of a technology trend analysis report generating system according to an exemplary embodiment of the present invention.

Referring to FIG. 1, a technology trend analysis report generating system 100 according to an exemplary embodiment of the present invention may include a input data storage unit 110 that manages and registers technology data required for technology trend analysis, a metadata storage unit 120, a data management module 130, a data registration module 140, and a registration data storage unit 150, an analysis object selection module 160, a report generating module for each analysis unit 170, an integrated report generating module 180, and a report management module 190.

Hereinafter, an operation of each component will be described in detail.

The input data storage unit 110 is configured to store at least one technology data input from the outside.

The metadata storage unit 120 is configured to store at least one of format information of the technology data, information defining technology classification of the technology data, and a technology element of the technology data.

Herein, the format information of the technology data includes configuration item information of the technology data and formation information of each item value.

Therefore, when the technology data are patent data, the format information of the technology data may include configuration item information that includes at least one item of a country code, a patent state code, importance, a technology classification, a technology element, an application number, a filing date, title of invention, abstract, representative claim, representative IPC, representative applicant, applicant, applicant nationality, inventor, inventor nationality, priority country, priority number, publication number, publication date, registration number, registration date, the number of claims, the number of citation patents, the number of cited patents, and the number of patent families.

Further, the format information for each item value on whether the values for each item, such as the country code item having an item value in a capital format of an English sentence such as KR, JP, EP, and the like, the item of filing date, publication date, and registration date having an item value in a yyyy-mm-dd format, and the abstract item having an item value in a format in which a length of a character string is limited within some characters, and the like, have any format may be included in the technology data format information.

The information defining the technology classification of the technology data may have a form like, for example, the following <Table 1> and <Table 2>.

TABLE 1

| | Middle | Small | Classification |
|---|---|---|---|
| Large classification | classification | classification | code |
| Four-generation | Key | Core structure | 11AA |
| sodium-cooled fast | system | Fluid flow in | 11AB |
| reactor technology | | core | |
| | | Reactivity | 11AC |
| | | control | |
| | Fluid | Conceptual | 11BA |
| | system | design of fluid | |
| | | system | |
| | | Safety system | 11BB |
| | | Power | 11BC |
| | | conversion | |
| | | system | |
| | | Sodium handling | 11BD |
| | | and safety | |
| | | Sodium process | 11BE |
| | | control | |

TABLE 2

| Large | Middle | Small | Classification |
|---|---|---|---|
| classification | classification | classification | code |
| Development | Very high | High temperature | 12AA |
| key | temperature gas | gas cooled | |
| technologies | cooled reactor and | reactor system | |
| for nuclear | system technology | Reactor system | 12AB |
| hydrogen | | Main cooling | 12AC |
| | | system | |
| | | Measurement | 12AD |
| | | system | |
| | | Control system | 12AE |
| | | Safety system | 12AF |
| | | Auxiliary system | 12AG |
| | Very high | Nuclear fuel | 12BA |
| | temperature gas | preparation and | |
| | cooled reactor | preparation | |
| | nuclear fuel | process | |
| | technology | Nuclear fuel | 12BB |
| | | handling | |
| | Nuclear hydrogen | Thermochemistry | 12CA |
| | production | hydrogen | |
| | technology | preparation | |
| | | Electrolysis | 12CB |
| | | hydrogen | |
| | | preparation | |
| | | Hybrid hydrogen | 12CC |
| | | preparation | |

As illustrated in the above <Table 1> and <Table 2>, the technology classification of the technology data is defined by a large classification, a middle classification, and a small classification and the technology classification code of the technology data may be defined so that the large classification of the technology data is divided into a number of two characters, the middle classification thereof is divided into an alphabet of one character, the small classification thereof is divided into an alphabet of one character.

Further, the information defining the technology elements of the technology data may have, for example, a form like, for example, the following <Table 3>.

Referring to <Table 3>, the technology elements of the technology data are defined by technology fields, technology element names, and technology element values and technology element codes of the technology data may be defined so that the technology field is divided into a number of two characters, the technology element name is divided into an alphabet of one character, and the technology element value is divided into an alphabet of one character.

TABLE 3

| | | | Technology |
|---|---|---|---|
| Technology | Technology | Technology element | element |
| field | element name | value | code |
| Four- | Method for | High combustion/Long | 11aa |
| generation | improving core | period achievement | |
| sodium- | system | Nuclear fuel charge | 11ab |
| cooled | performance | amount reduction | |
| fast | | design | |
| reactor | | Sodium vaporization | 11ac |
| technology | | reactivity reduction | |
| | | design | |
| | | Plutonium quality | 11ad |
| | | reduction design | |
| | | Simplification system | 11ae |
| | | design | |
| | | Structure material | 11af |
| | | amount reduction | |
| | | Passive/active | 11ag |
| | | reactivity control | |
| | | technology | |
| | | Thermal margin | 11ah |
| | | improvement design in | |
| | | core | |
| | | Structure material | 11ai |
| | | integrity improvement | |
| | | design | |
| | | Main device | 11aj |
| | | performance | |
| | | improvement | |
| | Core system | Durability improvement | 11ba |
| | technology | Economic efficiency | 11bb |
| | classification | improvement | |
| | for each purpose | Nuclear proliferation | 11bc |
| | | resistivity | |
| | | Safety improvement | 11bd |

Further, the metadata storage unit 120 may further include information on representative applicant standardization names for at least one technology data in consideration of the case in which the technology data stored in the input data storage unit 110 are patent data.

Herein, the information on the representative applicant standardization names of the technology data has a form like, for example, the following <Table 4>.

In general, even in the case of a plurality of patent data of the same applicant, there is a case in which applicant names included in each patent data are different. Therefore, in order to analyze the patent data, an operation of unifying an applicant name needs to be preceded.

In order to unify the representative applicant name, the information on the standardization name includes the representative applicant name and the representative applicant standardization name that are matched with each other.

TABLE 4

| | Representative |
|---|---|
| | applicant |
| | standardization |
| Representative applicant name | name |
| Doosan Heavy Industries & | Doosan Heavy |
| Construction Co. Ltd | Industries & |
| | Construction Co. |
| | Ltd |
| Doosan Heavy Industries & | Doosan Heavy |
| Construction Co. Ltd., Young | Industries & |
| Seok Yun | Construction Co. |
| | Ltd |
| Doosan Heavy Industries & | Doosan Heavy |
| Construction Co., Ltd. | Industries & |
| | Construction Co. |
| | Ltd |
| Samsung Electronics Co. Ltd | Samsung Electronics |
| | Co. Ltd |
| Samsung Electro. Co., Ltd. | Samsung Electronics |
| | Co. Ltd |
| Samsung Electronics Co. Ltd. | Samsung Electronics |
| | Co. Ltd |
| Samsung Electronics Co., Ltd. | Samsung Electronics |
| | Co. Ltd |
| Korea Atomic Energy Research | Korea Atomic Energy |
| Institute | Research Institute |
| Foundation Corporation Korea | Korea Atomic Energy |
| Atomic Energy Research | Research Institute |
| Institute, Pil Sun Han | |
| Korea Advanced Energy Research | Korea Atomic Energy |
| Institute | Research Institute |
| Korea Atomic Energy Research | Korea Atomic Energy |
| Institute, Jae In Shin | Research Institute |
| Korea Atomic Energy Research | Korea Atomic Energy |
| Institute | Research Institute |
| Korea Advanced Energy Research | Korea Atomic Energy |
| Institute | Research Institute |
| Korea Atom Energy Res Inst | Korea Atomic Energy |
| | Research Institute |
| Korea Atomic Energy Research | Korea Atomic Energy |
| Inst | Research Institute |

The data management module 130 verifies whether various kinds of formats, technology classification, or technology elements of the technology data stored in the input data storage unit 110 match the preset format, by using the information stored in the metadata storage unit 120.

Further, when it is determined based on the verification that the item values corresponding to the preset critical items are not present in the technology data or date item values, item values of the technology classification, or an item values of the technology elements within the technology data are different from the preset format, the data management module 130 sets the verification state of the corresponding technology data as an error state to match them with the corresponding technology data and stores the matched data in the input data storage unit 110.

In addition, when it is determined based on the verification that the format, the technology element, or the technology classification of the technology data match the preset format, the data management module 130 sets the verification state of the corresponding technology data as a ready state to match them with the corresponding technology data and store the matched technology data in the input data storage unit 110.

When there is the user modification of the technology data stored in the input data storage unit 110, the data management module 130 sets the verification state of the corresponding technology data as the modified state to match them with the corresponding technology data and store the matched technology data in the input data storage unit 110.

In addition, when the verification state of the technology data is an error state, the data management module 130 may provide an alarm message informing the error state and a request of modification, along with the corresponding technology data.

As another operation of the data management module 130, when at least one technology data from the outside is stored in the input data storage unit 110, the data management module 130 generates item values corresponding to at least one item that is preset for each stored technology data, matches the generated item values with the corresponding technology data, and stores the matched data in the input data storage unit 110.

For example, the data management module 130 may preset a input data management number, a representative applicant standardization name, or an item of application year, generate item values corresponding thereto using item values of each technology data, match the generated item values with the corresponding technology data and store the matched technology data.

In order facilitate an access to the technology data stored in the input data storage unit 110, the data management module 130 further generates data as the item values of each technology data.

As described above, the metadata storage unit 120 may further store the information on the representative applicant standardization name of the technology data.

Therefore, when the technology data are the patent data, the data management module 130 may use the information on the representative applicant standardization name stored in the metadata storage unit 120 to change and store the representative applicant name of at least one technology data stored in the input data storage unit 110 to the corresponding representative applicant standardization name.

The registration data storage unit 150 serves to store the plurality of pre-registered technology data for the technology trend analysis report.

The data registration module 140 registers at least one registration technology data in at least one technology data stored in the input data storage unit 110 depending on the verified state in the data management module 130 and the user registration request and stores the registered technology data in the registration data storage unit 150.

In detail, the data registration module 140 registers only the technology data having registration request of a user among the technology data of which the state verified in the data management module 130 corresponds to the ready state or the modified state and stores the registered technology data in the registration data storage unit 150.

As such, the data registration module 140 serves to select and register only the technology data used to allow the technology trend analysis report generating system 100 according to the present invention to generate a report among the technology data managed by the data management module 130.

Herein, the data registration module 140 selects the technology data to be registered by using the state verified by the data management module 130, such that the stability of the technology data used to generate the report may be increased and the reduction in reliability of the technology trend analysis results occurring due to the technology data error at the time of generating the report may be prevented previously.

Further, the data registration module 140 registers the technology data having the registration request of the user, such that the technology data used to generate the technology trend analysis report in response to the user request may be selected.

Meanwhile, in order to facilitate an access to at least one technology data stored in the registration data storage unit 150, the data registration module 140 may generate unique management numbers for each registered technology data, match the generated management number with the corresponding technology data, and store the matched technology data in the registration data storage unit 150.

Further, when at least one technology data is registered, the data registration module 140 uses each item value of the at least one registered technology data to generate index information and additionally store the generated index information in the registration data storage unit 150.

The index information generated by the data registration module 140 is information that is used to allow the registration data storage unit 150 to search the technology data to be used as the analysis object in the analysis object selection module 160 and the data registration module 140 serves to generate the index information while registering the technology data.

Herein, the technology trend analysis report generating system 100 according to the present invention including components that prefetch the technology data from the outside and perform the operation of managing and registering the prefetched technology data is described.

The technology data prefetched into the technology trend analysis report generating system 100 according to the present invention may be high-quality processed patent data used at the time of writing a patent map. Therefore, the patent data that are the input data are patent data processed to perform a filtering (filtering inappropriate documents) operation on raw-data rather than the raw-data acquired on a general patent search system and add the item values of the technology classification, the technology element, the importance, and the like.

Therefore, an object of the present invention is for a general researcher to easily write the patent trend analysis report as needed while prefetching, managing, updating, and maintaining the processed patent data previously used for the patent trend analysis report.

The analysis object selection module 160 is configured to select at least one technology data to be used as the analysis object in response to the user request from the registration data storage unit 150.

In detail, the analysis object selection module 160 may include an analysis object search unit 161, an analysis object management unit 163, and an analysis object storage unit 165.

The analysis object search unit 161 requests an input of a search keyword, a technology data related number, technology classification information, or technology element information to a user. Further, the analysis object search unit 161 searches at least one corresponding technology data from the registration data storage unit 150 depending on the user input.

Herein, the analysis object search unit 161 uses the index information generated from the data registration module 150 to perform the technology data search. The analysis object search unit 161 uses the index information to search the corresponding technology data in the registration data storage unit 150 depending on the search keyword, the technology data related number, the technology classification information, or the technology element information input by the user and provide the searched results.

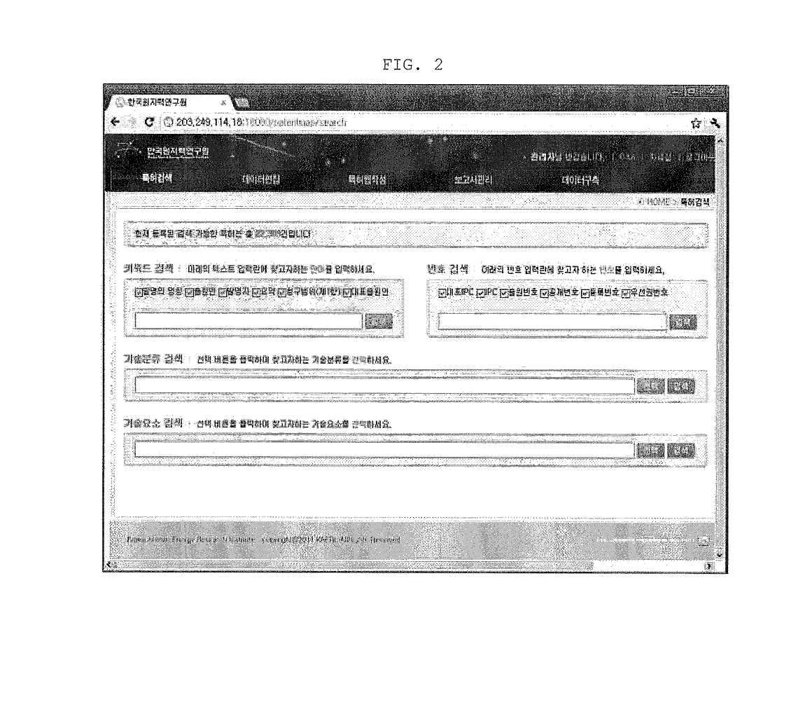

FIGS. 2 to 4 illustrate exemplary embodiments related to the analysis object search of the present invention. FIG. 2 illustrates an exemplary embodiment of searching the patent data as the analysis object for generating the patent trend analysis report.

As illustrated in FIG. 2, the analysis object search unit 161 may provide a user interface capable of performing a keyword search, a number search, a technology classification search, or a technology element search to receive search keys from a user.

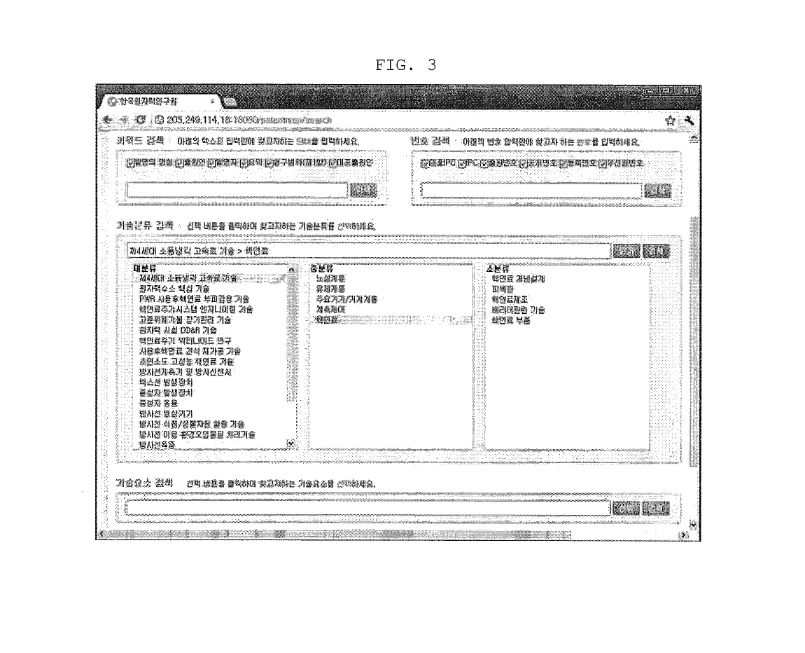

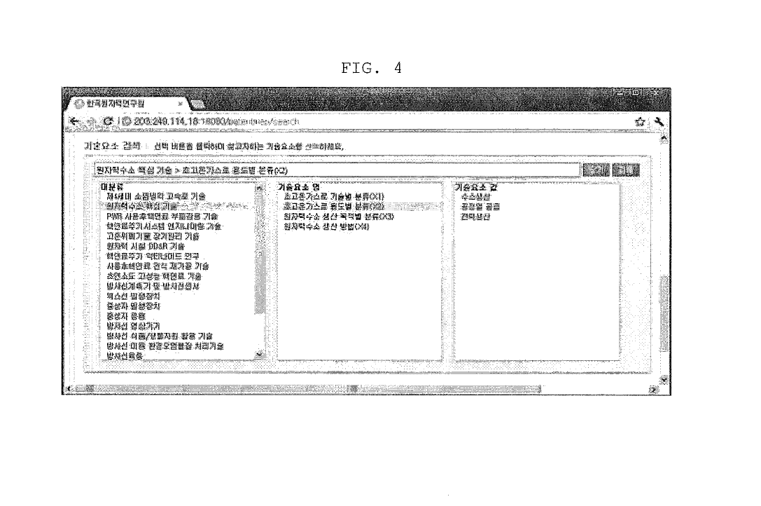

In particular, as illustrated in FIGS. 3 and 4, the search keys may be received from the user through the user interface capable of performing the technology classification search and the technology element search, respectively.

As described above, the technology classification may be defined by a large classification, a middle classification, and a small classification and the analysis object search unit 161 may select the large classification, the middle classification, and the small classification to be searched from the user to search the technology data corresponding to the selected classification.

Further, the technology element may be defined by a technology field corresponding to the large classification, the technology element name that is a lower concept of the technology field, and a technology element value that is a lower concept of the technology element name, and the analysis object search unit 161 may search the technology data corresponding to the selected technology element by selecting the technology fields, the technology element names, and the technology element values to be searched from the user.

The analysis object storage unit 165 stores at least one technology data searched by the analysis object search unit 161. The analysis object storage unit 165 provides a storage space in which at least one technology data selected as an analysis object for each user may be stored.

In order to select the analysis object in response to the user request, when the additional request of the analysis object of the user is input, the analysis object management unit 163 is operated to allow the user to search the technology data to be added as the analysis object in the analysis object search unit 161 and additionally store the searched technology data in the analysis object storage unit 165.

In addition, when the analysis object deletion request of the user is input, the analysis object management unit 163 is operated to delete the corresponding technology data from the analysis object storage unit 165 depending on the input deletion request.

Further, when the technology data are additionally stored in the analysis object storage unit 165, if there are overlapping technology data, the analysis object management unit 163 requests the user selection about whether to change the pre-stored technology data to newly stored technology data or store only the remaining non-overlapping technology data other than the overlapping previous technology data. Further, the analysis object management unit 163 serves to additionally store the technology data in the analysis object storage unit 165 depending on the user selection input by the request.

When there is the change command of the user for at least one technology data stored in the analysis object storage unit 165, the analysis object management unit 163 serves to change the technology data contents.

For example, when a technology classification information change instruction, a technology element information change instruction, or an applicant change instruction are input, the analysis object management unit 163 may serve to change the technology classification information, the technology element information, or the applicant information of the corresponding technology data depending on the input instruction and store the changed information in the analysis object storage unit 165.

The user may change the technology classification information, the technology element information, or the applicant name of the technology data to differently modify the analysis object according to his/her own purpose.

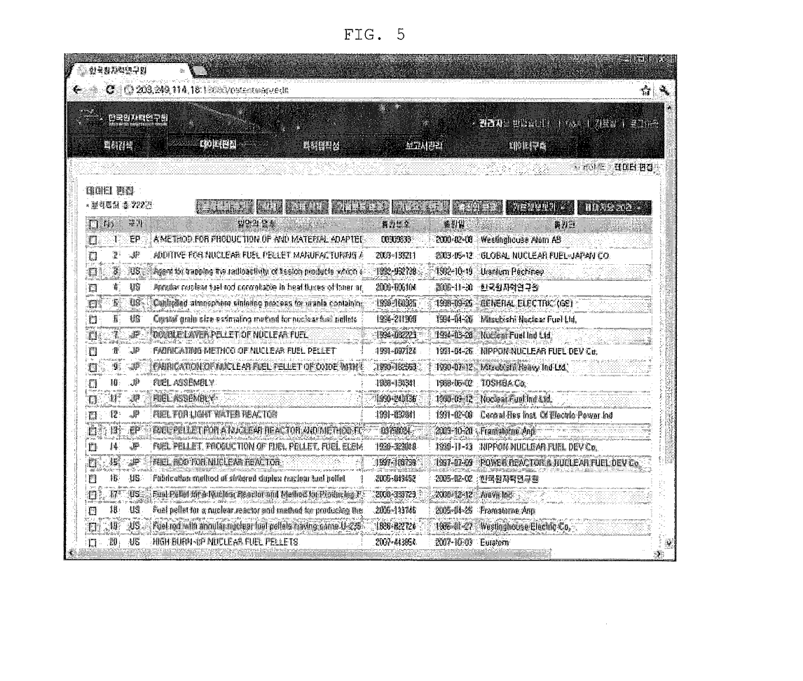

FIG. 5 illustrates an exemplary embodiment related to analysis object editing of the present invention and the operation of the analysis object management unit 163 will be described with reference to FIG. 5.

The patent data illustrated in FIG. 5 are results searched in the analysis object search unit 161, by the search keys input by the user.

The users may again search the patent data as the analysis object by the user interface illustrated in FIG. 5 to request the addition as the analysis object, the deletion of the patent data selected by the user among the searched patent data as the analysis object, or the technology classification, the technology element, or the applicant name change of the patent data selected by the user.

The analysis object management unit 163 serves to edit the analysis object in response to the corresponding request input from the user and store the edited analysis object in the analysis object storage unit 165.

The report generating module for each analysis 170 analyzes at least one technology data selected in the analysis object selection module 160 depending on a preset analysis reference. Further, the report generating module for each analysis 170 serves to generate at least one report for each analysis unit including the results analyzed depending on the analysis reference and a preset example sentence for description.

Therefore, the report generating module for each analysis 170 performs the technology data analysis corresponding to the analysis object depending on the preset analysis reference to provide the analyzed results and provide the preset example sentence for descriptions for each analysis reference as a report type.

When general researchers use the technology data analysis results to write the report, they may not know how to describe the corresponding analyzed results using any method. Therefore, at the time of writing the report, the quality of the report depends on ability to effectively describe the analyzed results for each analysis reference.

Therefore, in the present invention, the report generating module for each analysis 170 provides the analyzed results for each analysis unit and the reports for each analysis unit including the example sentence for description preferably describing the analyzed results. General researchers may more easily write a portion describing the corresponding analyzed results by referring to the example sentence for description present in the reports for each analysis unit.

Further, the preset example sentence for descriptions for each analysis reference in the report generating module for each analysis unit 170 may be configured by being divided into a fixed portion and a changed portion. Herein, the changed portion of the example sentence for description is an example sentence portion generated using the information extracted depending on the preset reference from the results obtained by analyzing the technology data for each analysis reference by the report generating module for each analysis unit 170 and the fixed portion of the example sentence for description is an example sentence portion inserted into the reports for each analysis unit by the report generating module for each analysis unit 170, regardless of the analyzed results.

For example, the reports for each analysis unit generated by the report generating module for each analysis unit 170 are reports in which the number of registered patents for each country is analyzed and it is assumed that the changed portion of the example sentence for description inserted into the reports has a reference previously set to extract the number of registered patents of USA, Korea, and China from the analyzed results. The report generating module for each analysis unit 170 extracts the number of registered patents of USA, Korea, and China from the results obtained by analyzing the number of registered patents for each country and generates an example sentence including information on how many the number of registered patents of USA, Korea, and China, respectively, are, as the changed portion of the example sentence for description. In addition, the overall example sentence for description may be completed by inserting the preset example sentence into the fixed portion of the example sentence for description along with the generated example sentence and a single report for each analysis unit may be generated along with the results obtained by analyzing the number of registered patent for each country.

In the present invention, when the example sentence for description of the user for at least one report for each analysis unit is changed, the report generating module for each analysis unit 170 serves to again generate the corresponding report for each analysis unit depending on the change of the example sentence.

In other words, when the user modifies the contents of the reports for each analysis unit provided to the user, the report generating module for each analysis unit 170 changes and stores the corresponding reports for each analysis unit in the modified state.

Therefore, as described above, the user may use the reports for each analysis unit provided from the report generating module for each analysis unit 170 to more easily perform the writing of the report.

Further, the report generating module for each analysis unit 170 pre-registers at least one report sample file for each analysis unit. Further, when the report sample request of the user is input, the report generating module for each analysis unit 170 may provide the report sample file requested by the user among the pre-registered report sample files in response to the input request.

Providing the report sample file by the report generating module for each analysis unit 170 is also to provide the writing convenience of the report to the user.

Preferably, the report generating module for each analysis unit 170 shows the analyzed results included in each report as chart images depending on a preset chart format for each analysis unit to generate the reports for each analysis unit.

Therefore, the report generating module for each analysis unit 170 presets the chart format that displays the analyzed results for each analysis reference well, generates the chart images displaying the analyzed results depending on the set chart format, and inserts the generated chart images into the corresponding report for each analysis unit.

Meanwhile, when there is a data request as the results analyzed by the user, the report generating module for each analysis unit 170 may provide the analyzed results corresponding to the chart images included in the corresponding reports for each analysis unit in response to the request as an excel file.

Therefore, the user may download the excel file having the analyzed results provided from the report generating module for each analysis unit 170 if necessary and use the downloaded excel file.

When generating the reports for each analysis unit, the report generating module for each analysis unit 170 may generate the reports as a Wiki format.

The user receives at least one report for each analysis unit generated as the Wiki format from the report generating module for each analysis unit 170 to edit the example sentence for description within each report, thereby more conveniently writing the reports for each analyzed results.

As described above, the report generating module for each analysis unit 170 according to the present invention provides the reports for each analysis unit having a form to allow a general user to understand the results obtained by analyzing the technology data for the technology trend analysis report and somewhat solve the difficulty in writing the description portion as the analyzed results.

Meanwhile, the report generating module for each analysis unit 170 may use the technology element information of at least one technology data selected by the analysis object selection module 160 in response to the user request to additionally set at least one analysis reference. In other words, the report generating module for each analysis unit 170 may use the technology element information of the selected technology data to provide the analyzable references to the analysis object and may set the references selected by the user as the analysis reference of the analysis object.

Therefore, a new analysis reference that may derive a vacant technology may be set based on the technology element information of the technology data corresponding to the analysis object.

The report generating module for each analysis unit 170 may analyze at least one technology data selected by the analysis object selection module 160 depending on the analysis reference set by the user request and additionally generate the reports for each analysis unit including the analyzed results and the preset example sentence for description.

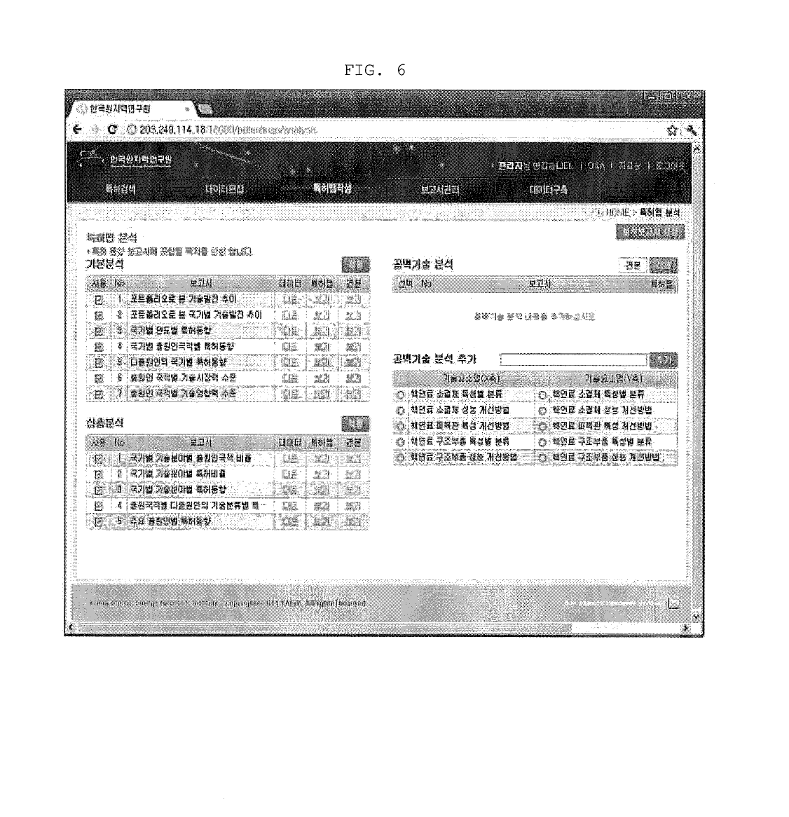

Hereinafter, an operation of the report generating module for each analysis unit 170 according to the present invention will be described with reference to FIGS. 6 to 8.

FIG. 6 is a first exemplary embodiment related to the report generation for each analysis unit of the present invention and the present invention may provide the reports for each analysis unit including the results obtained by analyzing the analysis object and the example sentence for description thereof, depending on analysis references preset as a basic analysis and analysis references set as an in-depth analysis by the report generating module for each analysis unit 170 as illustrated.

In addition, the report generating module for each analysis unit 170 may download the preset report sample file for each analysis reference in response to the user request, in addition to the reports for each analysis unit.

In addition, the report generating module for each analysis unit 170 may download and use the results obtained by analyzing the patent data corresponding to the analysis object for each analysis reference as the excel file in response to the user request.

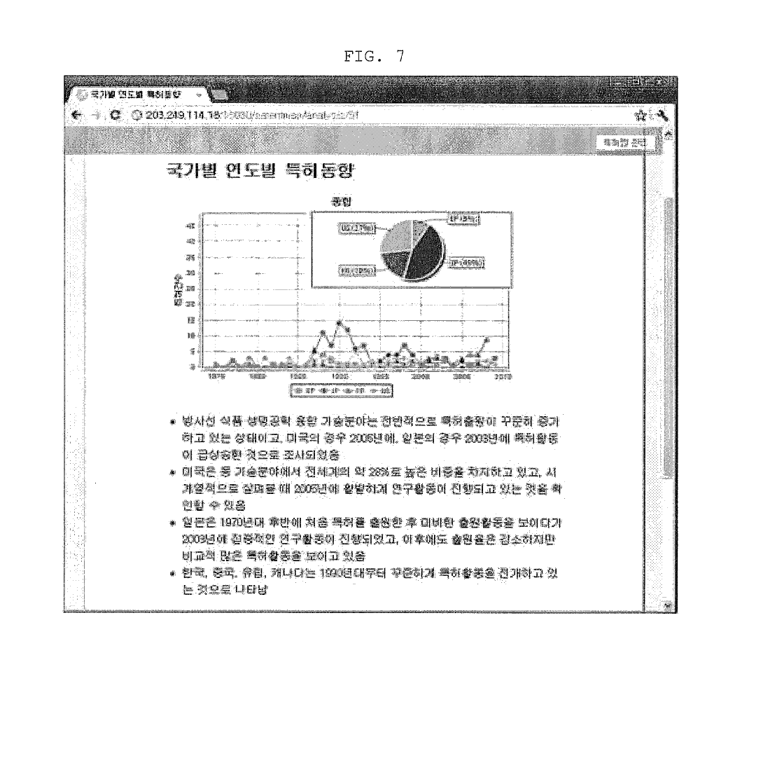

FIG. 7 is a second exemplary embodiment related to the report generation for each analysis unit of the present invention and illustrates an example of the reports for each analysis unit provided from the report generating module 170 for each analysis unit.

As illustrated in FIG. 7, the reports for each analysis unit may include a title and the results obtained by analyzing the analysis object depending on the analysis reference as the chart images depending on the preset chart format. Further, the reports for each analysis unit have a configuration to include the preset example sentence for description helping a user write the example sentence for the analyzed results illustrated as the chart images.

The present invention provides the reports for each analysis unit as illustrated in FIG. 7 to the user and enables the user to edit the example sentence for description contents, such that the user may conveniently reflect the example sentence for description editing of the user to write the corresponding reports for each analysis unit.

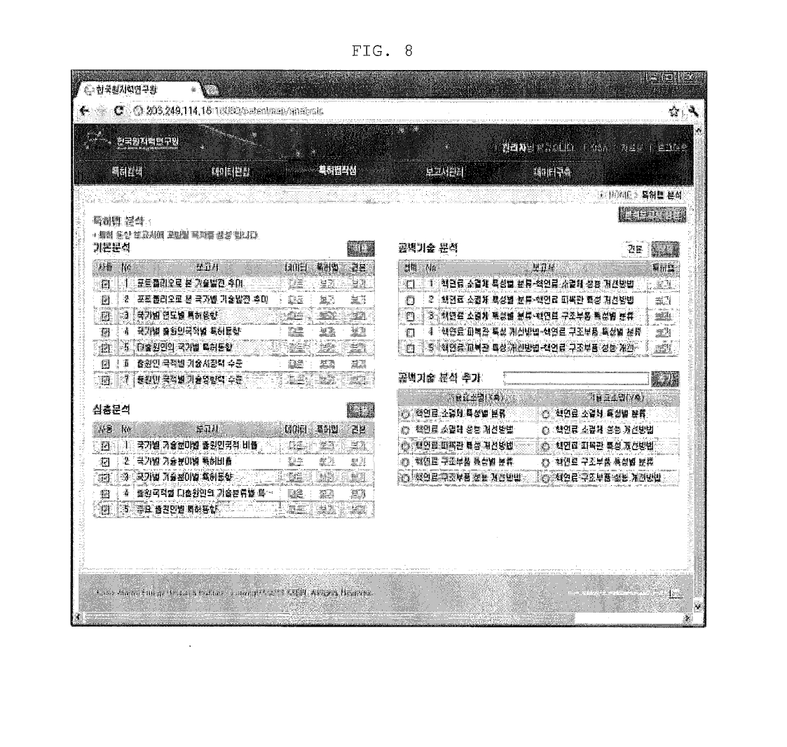

FIG. 8 is a third exemplary embodiment related to the report generation for each analysis unit of the present invention and as illustrated, the user may request a new analysis reference depending to the technology element information of the analysis object by designating an X-axis technology element name and a Y-axis technology element name at a portion at which a vacant technology analysis is added.

When the additional request of the new analysis reference is input as illustrated in FIG. 8, the present invention may analyze the analysis object depending on the requested analysis reference by the report generating module for each analysis unit 170 and additionally provide the reports for each analysis unit including the analyzed results and the example sentence for description thereof at the vacant technology analysis portion.

Therefore, the present invention may generate the new analysis reference analyzing the analysis object for analyzing the vacant technology of the analysis object in addition to the preset analysis reference and may provide the data analysis therefor and the reports for each analysis unit.

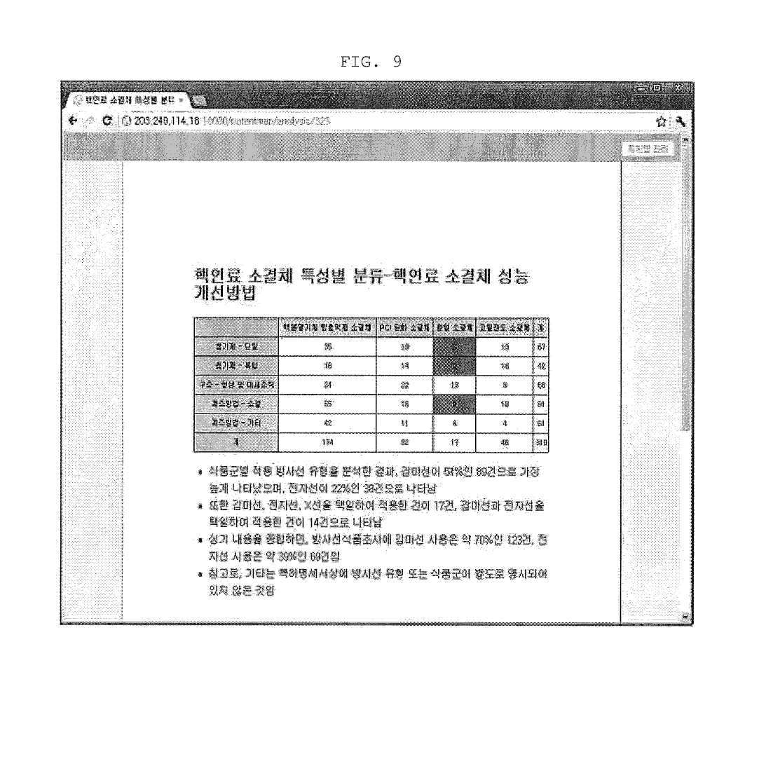

FIG. 9 is a diagram illustrating a fourth exemplary embodiment related to a report generation for each analysis unit of the present invention. FIG. 9 illustrates an example of the reports for each analysis unit including the results obtained by analyzing the description data depending on the analysis reference at which classifications for each nuclear fuel sintered body characteristic that is a new analysis reference are set to be an X axis and a method for improving the nuclear fuel sintered body is set to be a Y axis and the example sentence for description therefor.

As illustrated in FIG. 9, the reports for each analysis unit may be usefully used to analyze whether the vacant technology of the corresponding technology field is any portion.

In the technology trend analysis report generating system 100 according to the present invention, the integrated report generating module 180 has a configuration that combines at least one report for each analysis unit generated by the report generating module 170 for each analysis report depending on the preset technology trend analysis report to generate the technology trend analysis report.

The integrated report generating module 180 may use only at least one report for each analysis unit requested by the user among at least one report for each analysis unit generated by the report generating module for each analysis unit 170 to generate the technology trend analysis report so as to match the preset technology trend analysis report format.

The integrated report generating module 180 may include the reports for each analysis unit provided from the report generating module 170 for each analysis unit and may generate a single complete technology trend analysis report including a report cover, an introduction, a summary, contents, or a conclusion part, and the like.

Therefore, the integrated report generating module 180 may generate data for a specific report items using the reports for each analysis unit depending on the preset technology trend analysis report format and add the generated data to the technology trend analysis report. For example, the integrated report generating module 180 may use the title contents of the reports for each analysis unit included in the technology trend analysis report to generate the data for the items of the contents of the technology trend analysis report and include the generated data in the items of the contents at the time of generating the technology trend analysis report.

The integrated report generating module 180 may request the information to be inserted at the time of generating the technology trend analysis report to the user. Further, the information input from the user in response to the request may be added to the corresponding report items to match the preset technology trend analysis report format and the technology trend analysis report may be generated by combining the reports for each analysis unit.

The integrated report generating module 180 may preset at least one of a report introduction example sentence, a summary example sentence, and a conclusion example sentence for the technology trend analysis report and add at least one of the preset report introduction example sentence, summary example sentence, and conclusion example sentence at the time of generating the technology trend analysis report to the corresponding report items to match the preset technology trend analysis report format.

Therefore, the integrated report generating module 180 may automatically generate one technology trend analysis report completely including a cover, an introduction, a main subject, and a conclusion and provide the generated report to the user.

The integrated report generating module 180 may be configured to generate the technology trend analysis report as the Wiki format.

Further, the integrated report generating module 180 according to the exemplary embodiment of the present invention may be configured to transform and provide the generated technology trend analysis report into a Hangul or word file in response to the user request. Therefore, the integrated report generating module 180 may allow the user to download the technology trend analysis report document in the Wiki format as the document transformed into the document in the Hangul or word format, such that the report writing operation may be extendedly performed even at the outside of the system 100 as well as in the system 100 in response to the user request.

The report management module 190 serves to store and manage the technology trend analysis report generated from the integrated report generating module 180. Therefore, when the contents of the technology trend analysis report generated and provided from the integrated report generating module 180 are changed by the user, the report management module 190 re-stores and manages the technology trend analysis report as the changed contents.

Further, the report management module 190 matches at least one technology data selected by the analysis object selection module 160 with the technology trend analysis report generated from the integrated report generating module 180 to generate the technology trend analysis report. Further, when the technology data used in the technology trend analysis report is requested from the user, at least one technology data matched with the technology trend analysis report is provided to the user.

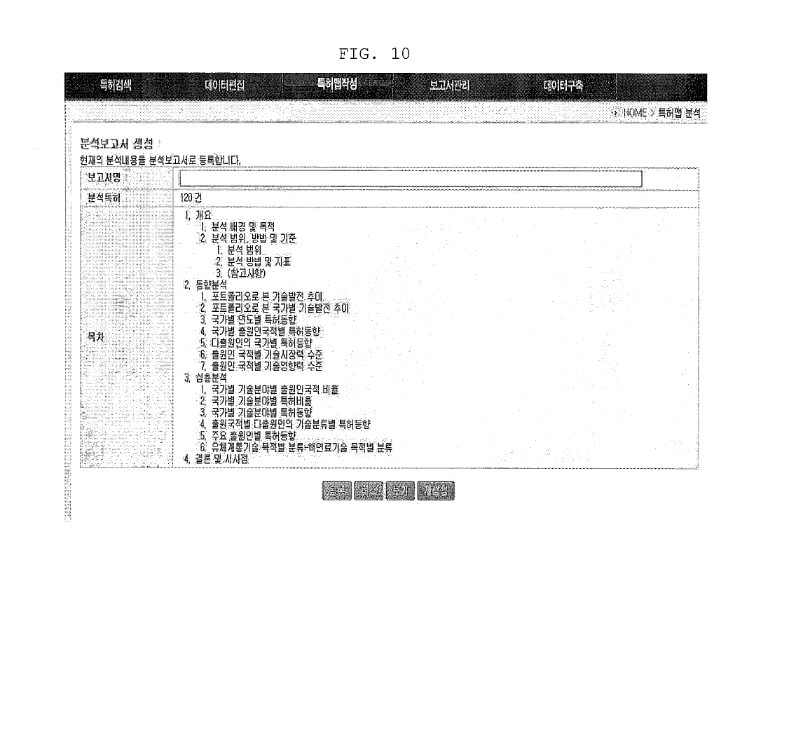

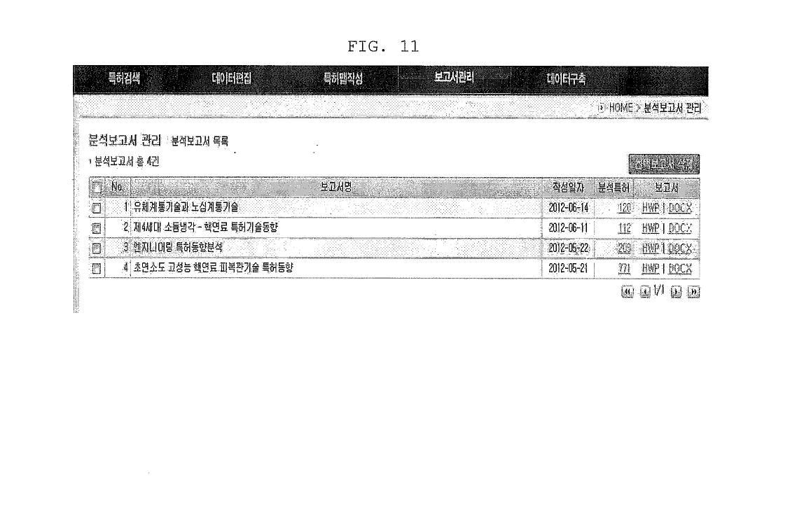

Hereinafter, the operation of the integrated report writing module 180 and the report management module 190 will be described with reference to FIGS. 10 and 11.

FIG. 10 is a diagram illustrating an exemplary embodiment related to the technology trend analysis report generation of the present invention and as illustrated in FIG. 10, the integrated report generating module 180 may receive the report title name from the user and add the input title name as a title at the time of generating the technology trend analysis report.

In addition, as illustrated in FIG. 9, the report contents information may be generated using the combined order of the reports for each analysis unit and the preset contents item values depending on the preset format of the technology trend analysis report and added at the time of generating the report.

The integrated report generating module 180 generates the technology trend analysis report for the analysis object by the report generation request of the user.

The present invention allows the user to receive at least one report generated as the Wiki format and modify and edit the contents, the introduction, the summary, the main subject, or the conclusion example sentence to more conveniently write the technology trend analysis report.

FIG. 11 is a diagram illustrating an exemplary embodiment related to the technology trend analysis report management of the present invention and illustrates the exemplary embodiment of providing and managing the technology trend analysis report generated by the report generation request of the user to the user.

As illustrated in FIG. 11, the present invention may transform the technology trend analysis report document into the document in the Hangul (HWP) or word (DOCX) format by the integrated report generating module 180 and download the transformed document in response to the user selection.

Further, when the analysis patent request instruction of the user is input, the present invention may be configured to provide the patent data corresponding to the analysis object used in the corresponding technology trend analysis report by the report management module 190.

As described above, components configuring the technology trend analysis report generating system 100 according to the present invention and the operation thereof will be described.

The technology trend analysis report generating system 100 according to the present invention allows the general users to directly access the system 100 to search the analysis object technology data by the foregoing configuration and then perform the process of analyzing the technology data, generating the reports for each analysis unit, and generating the integrated report, thereby obtaining the final technology trend analysis report.

The present invention may reuse the high-quality processed patent data generated during the progress of the previously performed patent trend analysis business, such that the user can more easily write the patent trend analysis report.

According to the exemplary embodiment of the present invention, the high-quality patent data used at the time of writing the patent trend analysis report need to be accumulated, managed, updated, and maintained at a national or organization level, such that the high-quality processed patent data generated by the patent trend analysis business for each technology field can be prevented from being discarded and can be continuously reused. Further, the exemplary embodiment of the present invention can helps the general researchers to easily and rapidly write the patent trend analysis report.

The exemplary embodiment of the present invention can easily and rapidly perform the writing operation of the patent trend analysis report by allowing researchers of each organization, research planning/operation division, policy division/board of directors, and the like, to use the high-quality patent data according to their own purpose and largely reduce the manpower and budget consumed to write the patent trend analysis report.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Therefore, the idea of the present invention is to be understood only by the following claims, and therefore the equivalents or equivalent changes are to be construed as being included in the scope of the present invention.

What is claimed is:

1. A technology trend analysis report generating system, comprising:
a registration data storage unit that stores a plurality of pre-registered technology data for a technology trend analysis report;
an analysis object selection module that selects at least one technology data to be used as an analysis object in response to a user request from the registration data storage unit;
a report generating module for each analysis unit that analyzes at least one technology data selected by the analysis object selection module depending on a preset analysis reference and generates at least one report for each analysis unit including results analyzed depending on the analysis reference and a preset example sentence for description; and
an integrated report generating module that combines at least one report for each analysis unit generated from the report generating module for each analysis unit depending on a preset technology trend analysis report format to generate a technology trend analysis report.

2. The technology trend analysis report generating system of claim 1, wherein the analysis object selection module includes:
an analysis object search unit that requests an input of a search keyword, a technology data related number, technology classification information, or technology element information to a user and searches at least one corresponding technology data in the registration data storage unit in response to a user input; and
an analysis object storage unit that stores at least one technology data searched by the analysis object search unit.

3. The technology trend analysis report generating system of claim 2, wherein the analysis object selection module includes:
an analysis object management unit that allows the user to search the technology data to be added as the analysis object and additionally store the searched technology data in the analysis object storage unit when an additional request of the analysis object of the user is input, deletes the corresponding technology data from the analysis object storage unit depending on the input deletion request when the analysis object deletion request of the user is input, or receives the user selection about whether to change a pre-stored technology data to a newly stored technology data or store only the remaining non-overlapping technology data other than the overlapping previous technology data and additionally stores the technology data in the analysis object storage unit in response to the input user selection if there are overlapping technology data when the technology data is additionally stored in the analysis object storage unit.

4. The technology trend analysis report generating system of claim 3, wherein the analysis object management unit changes technology classification information, technology element information, or applicant information of the corresponding technology data in response to an input instruction and stores the changed information in the analysis object storage unit when a technology classification information change instruction, a technology element information change instruction, or an applicant change instruction are input.

5. The technology trend analysis report generating system of claim 1, wherein a example sentence for description preset in the report generating module for each analysis unit is configured by being divided into a fixed portion and a changed portion, and
the report generating module for each analysis unit generates the changed portion of the description anchor portion by extracting the corresponding information depending on a preset reference in results obtained by analyzing the technology data and using the extracted information.

6. The technology trend analysis report generating system of claim 1, wherein the report generating module for each analysis unit again generates the corresponding report for each analysis unit depending on the change of the example sentence, when the example sentence for description of the user for at least one report for each analysis unit is changed.

7. The technology trend analysis report generating system of claim 1, wherein the report generating module for each analysis unit pre-registers at least one report sample file for each analysis unit, and provides the corresponding report sample file among the pre-registered report sample files in response to the input request, when the report sample request of the user is input.

8. The technology trend analysis report generating system of claim 1, wherein the report generating module for each analysis unit shows the analyzed results as chart images depending on preset chart formats for each analysis unit to generate the reports for each analysis unit, and provides the analyzed results corresponding to the chart images included in the corresponding reports for each analysis unit in response to the request as an Excel file when there is a data request as the analyzed results of the user.

9. The technology trend analysis report generating system of claim 1, wherein the report generating module for each analysis unit generates the reports for each analysis unit as a Wiki format.

10. The technology trend analysis report generating system of claim 1, wherein the report generating module for each analysis unit additionally generates at least one analysis reference for analyzing a vacant technology using technology element information of at least one technology data selected by the analysis object selection module in response to the user request, analyzes at least one technology data selected by the analysis object selection module according to the generated analysis reference, and additionally generates at least one report for each analysis unit including the analyzed results and a preset example sentence for description.

11. The technology trend analysis report generating system of claim 1, wherein the integrated report generating module combines only at least one report for each analysis unit requested by the user among at least one report for each analysis unit generated by the report generating module for each analysis unit so as to match the preset technology trend analysis report format to generate the technology trend analysis report.

12. The technology trend analysis report generating system of claim 1, wherein the integrated report generating module requests information to be inserted at the time of generating the technology trend analysis report to the user, adds information input from the user according to the request so as to match the preset technology trend analysis report format, and combines at least one report for each analysis unit to generate the technology trend analysis report.

13. The technology trend analysis report generating system of claim 12, wherein the integrated report generating module presets at least one of a report introduction example sentence, a summary example sentence, and a conclusion example sentence for the technology trend analysis report, and adds at least one of an introduction example sentence, a summary example sentence, and a conclusion example sentence so as to match the preset technology trend analysis report format at the time of generating the technology trend analysis report to generate the technology trend analysis report.

14. The technology trend analysis report generating system of claim 1, wherein the integrated report generating module generates the technology trend analysis report as a Wiki format.

15. The technology trend analysis report generating system of claim 1, wherein the integrated report generating module transforms and provides the generated technology trend analysis report into a Hangul or word file in response to the user request.

16. The technology trend analysis report generating system of claim 1, further comprising:
a report management module that stores the technology trend analysis report generated by the integrated report generating module and when the contents of the technology trend analysis report generated are changed by the user, re-stores and manages the technology trend analysis report as the changed contents.

17. The technology trend analysis report generating system of claim 16, wherein the report management module matches at least one technology data selected by the analysis object selection module with the technology trend analysis report generated from the report generating module to generate the technology trend analysis report, and when the technology data used in the technology trend analysis report is requested from the user, provides the at least one technology data matched with the technology trend analysis report.

18. The technology trend analysis report generating system of claim 1, further comprising:
a input data storage unit that stores at least one technology data input from the outside;
a metadata storage unit that stores at least one of format information of the technology data, information defining a technology element of the technology data, and a technology classification of the technology data; and
a data management module that verifies the format, the technology element, or the technology classification of at least one technology data stored in the input data storage unit using the information stored in the metadata storage unit, matches the verified state with the corresponding technology data and stores the matched data in the input data storage unit.

19. The technology trend analysis report generating system of claim 18, wherein the data management module informs that the modification of the corresponding technology data is required when the verified state is a state required to modify the corresponding technology data and edits the corresponding technology data depending on the modification request input from the user.

20. The technology trend analysis report generating system of claim 18, wherein the data management module generates a data corresponding to at least one item preset for the at least one stored technology data, matches the generated data with the corresponding technology data, and stores the matched data in the input data storage unit, when at least one technology data from the outside is stored in the input data storage unit.

21. The technology trend analysis report generating system of claim 18, wherein the metadata storage unit further includes information on a representative applicant standardization name for the at least technology data, and the data management module uses the information on the representative applicant standardization name to change and store a representative applicant name of at least one technology data stored in the input data storage unit to the corresponding representative applicant standardization name.

22. The technology trend analysis report generating system of claim 18, further comprising:
registers at least one registration technology data in at least one technology data stored in the input data storage unit depending on the verified state in the data management module and the user registration request and stores the registered technology data in the registration data storage unit.

23. The technology trend analysis report generating system of claim 22, wherein the data registration module generates unique management numbers for each registered technology data and matches and stores the generated management number with the corresponding technology data.

24. The technology trend analysis report generating system of claim 22, wherein the data registration module uses the registered technology data to generate index information on the corresponding technology data and additionally stores the generated index information in the registration data storage unit, when the technology data is registered.

25. A computer-readable recording medium recorded with a program executing a method for generating a technology trend analysis report, the method for generating a technology analysis report comprising:
selecting at least one technology data to be used as an analysis object in response to a user request among a plurality of pre-registered technology data for a technology trend analysis report;
analyzing the at least selected technology data depending on a preset analysis reference and generating at least one report for each analysis unit including results analyzed depending on the analysis reference and a preset example sentence for description; and
combining the at least one generated report for each analysis unit depending on the preset technology trend analysis report format to generate a technology trend analysis report.
